(19) United States
(12) Patent Application Publication
(10) Pub. No.: US 2026/0367823 A1
(43) Pub. Date: Nov. 19, 2026

(54) MEMORY SYSTEM AND METHOD OF OPERATING THE MEMORY SYSTEM

(71) Applicant: SK hynix Inc., Icheon-si (KR)

(72) Inventor: Hee Chang KIM, Icheon-si (KR)

(21) Appl. No.: 19/369,119

(22) Filed: Oct. 24, 2025

(30) Foreign Application Priority Data
May 19, 2025 (KR) 10-2025-0064639

(51) Int. Cl. G06F 3/06

(52) U.S. Cl. CPC G06F 3/0655; G06F 3/0653; G06F 3/0679

(57) ABSTRACT

A memory system includes a memory device including a plurality of memory blocks, a temperature sensor configured to measure the temperature of the memory blocks, and a memory controller configured to control the memory device. In a method of operating the memory system the memory controller performs a write operation on the memory device at a first temperature of the memory blocks; performs a first read operation on the memory device at a second temperature of the memory blocks; compares the first temperature with the second temperature when it determines that a read failure of a specific block occurs in the first read operation; and performs a second read operation on the specific block in response to the temperature of the specific block being within a predetermined temperature range corresponding to the first temperature when the first temperature and the second temperature are included in different predetermined temperature ranges.

This application claims priority to and the benefit of Korean Patent Application No. 10-2025-0064639, filed on May 19, 2025, the disclosure of which is incorporated herein by reference in its entirety.

### BACKGROUND

### Technical Field

Embodiments of the present disclosure relate to a memory system and a method of operating the memory system.

### Background of the Disclosure

A memory system is a system configured to store data based on requests from a host (e.g., an external device), such as a computer, a mobile terminal such as a smartphone or tablet, or various electronic devices.

The memory system may include a memory and a memory controller for controlling the memory. The memory controller may receive a command from a host and execute or control operations for reading data from the memory, writing/programming data to the memory, or erasing data from the memory based on the received command.

### SUMMARY

Accordingly, one object of the present disclosure is to provide a memory system that may prevent errors due to temperature differences during write and read operations.

Another object of the present disclosure is to provide a memory system that may perform stable operations.

The objects of the present disclosure are not limited to those mentioned above, and other technical features and objects can be inferred from the following embodiments.

According to one embodiment to solve the objects, a method of operating a memory system including a memory device including a plurality of memory blocks and a temperature sensor configured to measure the temperature of the memory blocks; and a memory controller configured to control the memory device, the method may include a step in which the memory controller performs a write operation on the memory device at a first temperature of the memory blocks; a step in which the memory controller performs a first read operation on the memory device at a second temperature of the memory blocks according to a request of a host; a step in which the memory controller determines whether a read failure of a specific block occurred in the first read operation; a step in which the memory controller compares the first temperature with the second temperature in response to determining that the read failure of the specific block occurred in the first read operation; and a step in which the memory controller performs a second read operation on the specific block in response to the temperature of the specific block being within a temperature range equal to the first temperature when the first temperature and the second temperature are included in different predetermined temperature ranges.

According to another embodiment, a memory system may include a memory device including a plurality of memory blocks and a temperature sensor configured to measure the temperature of the memory blocks; and a memory controller for controlling the memory device. The memory controller may be configured to compare a first temperature of the specific block at a write operation prior to a first read operation with a second temperature of the specific block at the first read operation, when a read failure of a specific block is determined in a first read operation for the memory block, and perform a second read operation for the specific block in response to the temperature of the specific block being located within the same temperature range as the first temperature, when the first temperature and the second temperature are included in different temperature ranges.

Further scope of applicability of the present invention will become apparent from the detailed description given hereinafter.

According to the embodiments, the memory system may prevent errors due to temperature differences during write and read operations by compensating for read failures caused by the threshold voltage of a memory cell that changes when the temperatures of the write and read operations are different.

Furthermore, the memory system may operate stably by recognizing a block in which a read failure occurs due to a threshold voltage of a memory cell that changes when the respective temperatures are different during a write operation and a read operation as a bad block and not using it for future data storage.

Still further, according to the embodiments of the present disclosure, the memory system may operate stably by compensating for read failures caused by threshold voltages of memory cells that change when the temperatures of write and read operations are different, storing data of a block in another block, and preventing read failures caused by temperature differences in subsequent read and write operations.

However, it should be understood that the detailed description and specific examples, while indicating preferred embodiments of the invention, are given by illustration only, since various changes and modifications within the spirit and scope of the invention will become apparent to those skilled in the art from this detailed description.

### DESCRIPTION OF DRAWINGS

FIG. 1 is a schematic view of a memory system according to one embodiment;

FIG. 2 is a diagram showing configurations of a memory shown in FIG. 1;

FIG. 3 is a circuit view showing the structure of a memory block shown in FIG. 2;

FIG. 4 is a flow chart showing a method of operating a memory system according to one embodiment;

FIG. 5 is a diagram to describe S20 of FIG. 4:

FIG. 6 is a diagram to describe S50 of FIG. 4;

FIG. 7 is a diagram to describe S80 of FIG. 4;

FIG. 8 is a diagram to describe S90 of FIG. 4;

FIG. 9 is a flow chart showing a temperature control operation according to one embodiment; and

FIG. 10 is a flow chart showing a temperature control operation according to another embodiment.

### DESCRIPTION OF SPECIFIC EMBODIMENTS

Description will now be given in detail according to illustrative embodiments disclosed herein, with reference to the accompanying drawings.

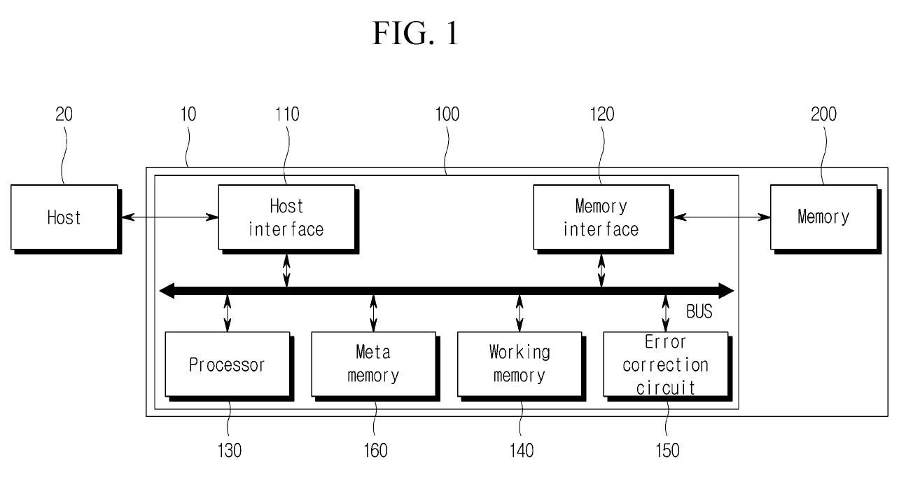

FIG. 1 is a schematic view of a memory system according to one embodiment.

Referring to FIG. 1, the memory system 10 according to one embodiment may include a memory 200 configured to store data and a memory controller 100 configured to control the memory 200.

The memory system 10 may operate by the memory controller 100 configured to receive a command for controlling operation from the host 20, and the memory controller 100 transmitting the command to the memory 200 accordingly. In some operations, the memory controller 100 may perform an operation for controlling the memory 200 on its own without a command from the host 20.

The memory 200 includes a plurality of memory blocks (Memory Blocks; BLK) and operates in response to the control of the memory controller 100. Here, the operation of the memory 200 may include, for example, a read operation, a write operation (also called a “program operation”), and an erase operation (an erase operation).

For example, the memory 200 may be a nonvolatile memory including memory cells that perform a read operation using a threshold voltage, such as NAND Flash Memory, 3D NAND Flash Memory, NOR Flash Memory, etc. The memory 200 may be a flash memory in which a charge storage layer is composed of a conductive floating gate, or a charge trap flash (CTF) memory in which a charge storage layer is composed of an insulating film.

The memory 200 may receive a command and an address from the memory controller 100 and access an area selected by the address among the memory cell arrays. That is, the memory 200 may perform an operation directed by the command for an area selected by the address.

For example, the memory 200 may perform a write operation, a read operation, an erase operation, etc. During a write operation, the memory 200 may store data in an area selected by an address. During a read operation, the memory 200 may read data from an area selected by an address. During the erase operation, the memory 200 may erase data stored in an area selected by an address.

The memory controller 100 may control write, read, erase, and background operations for the memory 200. Here, the background operation may include one or more of Garbage Collection (GC), Wear Leveling (WL), Read Reclaim (RR), or Bad Block Management (BBM) operations.

The host 20 maybe one of the known devices in the art that may be linked with the memory system 10.

The host may include at least one operating system (OS). The operating system may manage and control the overall functions and operations of the host, and may provide mutual operations between the host and the memory system 10.

The memory controller 100 may include a host interface 110, a memory interface 120, a processor 130, a working memory 140, an error correction circuit 150, and a meta memory 160.

The host interface 110 provides an interface for communication with the host. For example, the host interface 110 may provide an interface that uses at least one of various interface protocols, such as a USB (Universal Serial Bus) protocol, an MMC (multimedia card) protocol, a PCI (peripheral component interconnection) protocol, a PCI-E (PCI-express) protocol, an ATA (Advanced Technology Attachment) protocol, a Serial-ATA protocol, a Parallel-ATA protocol, a SCSI (small computer small interface) protocol, an ESDI (enhanced small disk interface) protocol, an IDE (Integrated Drive Electronics) protocol, an SMBus (system management bus) protocol, an I2C (inter-integrated circuit) protocol, an I3C (improved inter-integrated circuit) protocol, a proprietary protocol, etc.

The memory interface 120 may be connected to the memory 200 and provide an interface for communication with the memory 200.

The processor 130, working memory 140, error correction circuit 150, and meta memory 160 may operate as a control circuit to perform the overall control operation of the memory controller 100.

The processor 130 may perform the overall control operation of the memory controller 100 to control the operation of the memory 200. The processor 130 may control the overall operation of the memory controller 100. The processor 130 may communicate with the host through the host interface 110 and communicate with the memory 200 through the memory interface 120.

The processor 130 may perform the function of a flash translation layer (FTL). The processor 130 may convert a logical block address provided by the host into a physical block address through the flash translation layer (FTL). The flash translation layer may receive a logical block address using a mapping table and convert it into a physical block address.

The processor 130 may control the operation of the memory controller 100 by executing firmware. In other words, the processor 130 may control the overall operation of the memory controller 100 and execute (drive) the firmware stored in the working memory 140 at booting. The operation of the memory system 10 described in the following embodiments may be implemented in a manner in which the processor 130 executes the firmware in which the corresponding operation is defined.

Firmware is a program that is executed within the memory system 10 to drive the memory system 10, and may include various functional layers. For example, the firmware may include binary data in which codes for executing each of the aforementioned functional layers are defined.

For example, the firmware may include a flash translation layer that performs a conversion function between a logical block address transmitted from the host to the memory system 10 and a physical block address of the memory 200, a host interface layer HIL that interprets a command received from the host through the host interface 110 and transmits it to the flash translation layer, and a flash interface layer FIL that transmits a command instructed by the flash translation layer to the memory 200.

The processor 130 may perform logical operations defined in the firmware loaded into the working memory 140 to control the overall operation of the memory controller 100. The processor 130 may store the result of performing a logical operation defined in the firmware in the working memory 140.

The processor 130 may load the meta data (or data) required to drive the firmware from the meta memory 160.

The working memory 140 may store the firmware, program code, command or data required to drive the memory controller 100. The working memory 140 may include, for example, one or more of SRAM (Static RAM), DRAM (Dynamic RAM) and SDRAM (Synchronous DRAM) as volatile memory.

The error correction circuit 150 may detect error bits of target data using an error correction code and correct the detected error bits. Here, the target data may be, for example, data stored in the working memory 140 or data read from the memory 200.

The error correction circuit 150 may perform an error correction operation on a block of the memory 200 that has failed a read operation (Read FAIL). In particular, the error correction circuit 150 may detect error bits in chunk units during a read operation. A chunk may mean a data unit smaller than a page that constitutes a memory block. In a read operation, chunks in which each data is stored may be distinguished using an address. The error correction circuit 150 may sequentially perform an error correction operation on all data stored in the memory 200 while performing a read operation.

The processor 130 may determine and detect that an Uncorrectable Error Correction Code (UECC) occurs in a block including a chunk that has failed an error correction operation.

The meta memory 160 may store firmware, program code, commands, or data required to drive the memory controller 100. In some embodiments, the meta memory 160 may not be configured within the memory controller 100, but may be configured in the memory 200.

Some components of the configuration 110, 120, 130, 140, 150, and 160 of the memory controller 100 may not be included in the memory controller 100 but may be provided in a separate electronic device. In addition, some components of the configuration 110, 120, 130, 140, 150, and 160 of the memory controller 100 may be integrated and operated as one. Therefore, the configuration of the memory controller 100 is not limited to what is shown in FIG. 1.

According to one embodiment, the memory controller 100 may further include a temperature sensor for measuring the temperature of the memory controller 100 itself, either inside or outside the memory controller 100.

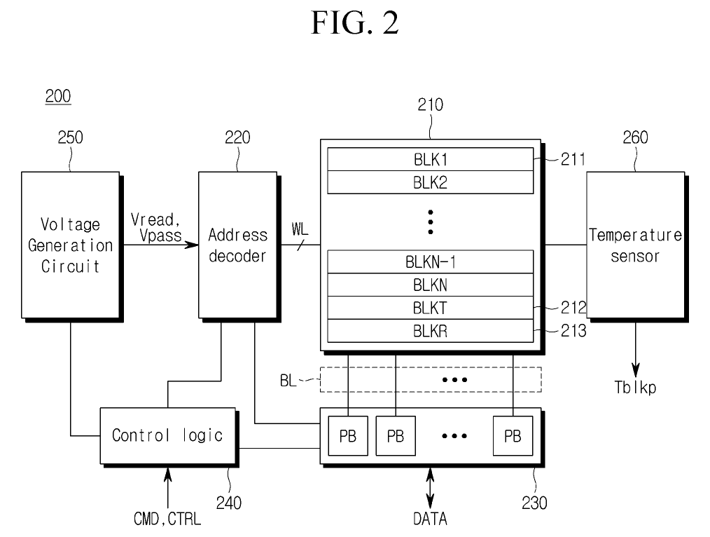

FIG. 2 is a diagram showing configurations of a memory shown in FIG. 1.

Referring to FIG. 2, the memory 200 according to one embodiment may include a memory cell array 210, an address decoder 250, a read and write circuit 230, a control logic 240, a voltage generation circuit 250, and a temperature sensor 260.

The memory cell array 210 may include two or more natural numbers N of memory blocks BLK1 to BLKN, 211, a temperature storage block BLKT, 212, and a bad information block BLKR, 213.

The memory 200 may include a plurality of memory dies including a plurality of memory cell arrays 210. A memory die is the minimum unit that divides a wafer in the semiconductor chip manufacturing process, and may include a plurality of memory cell arrays 210, other control circuits, and input/output circuits.

The memory block 211 may store data. The temperature storage block 212 may store the temperature of a memory block 211 when a read operation is performed on the memory block 211. The bad information block 213 may store failure information of a block where a UECC occurs.

A plurality of word lines WL and bit lines (BL) are arranged in the memory block 211, the temperature storage block 212, and the bad information block 213, and the plurality of memory cells can be arranged.

The memory block 211, the temperature storage block 212, and the bad information block 213 may be connected to the address decoder 220 through the plurality of word lines (WL) and to the read and write circuit 230 through the plurality of bit lines (BL).

The temperature storage block 212 and the bad information block 213 may be provided in a separate memory cell array from the memory block 211.

Referring to FIG. 2, the address decoder 220, the read and write circuit 230, the control logic 240, and the voltage generation circuit 250 may operate as peripheral circuits that drive the memory cell array 210.

The address decoder 220 may operate in response to the control of the control logic 240. The address decoder 220 may receive an address through an input/output buffer inside the memory 200. The address decoder 220 may be configured to decode a block address among the received addresses. The address decoder 220 may select at least one memory block 211 according to the decoded block address.

The address decoder 220 may receive a read voltage Vread and a pass voltage Vpass from the voltage generation circuit 250.

The address decoder 220 may apply a read voltage Vread to a selected word line WL in a selected memory block 211 during a voltage application operation during a read operation, and may apply a pass voltage Vpass to an unselected word line WL. In addition, the address decoder 220 may apply an error verification and correction voltage generated by the voltage generation circuit 250 to the selected word line WL during an error correction operation of the error correction circuit 150.

The address decoder 220 may decode a column address among the received addresses. The address decoder 220 may transmit the decoded column address to the read and write circuit 230.

The read operation and the write operation of the memory 200 may be performed in units of pages constituting the memory block 211. The read and write operation of the memory 200 may be performed by reading data stored in each chunk constituting the page or storing data in each chunk.

The address decoder 220 may decode a row address among the received addresses. In addition, the address decoder 220 may decode a block address among the received addresses. The row address may indicate the address of a specific page. The block address may indicate the address of the memory block 211 including multiple pages.

The address decoder 220 may select one memory block 211 and one word line WL according to the block address and the row address.

The address decoder 220 may include a column address decoder, a row decoder, and a block decoder for decoding each of the column address, the row address, and the block address. In addition, the address decoder 220 may include an address buffer for performing a decoding operation.

The read and write circuit 230 may be a page buffer circuit including a plurality of page buffers PB. The read and write circuit 230 may additionally include a data buffer (Data Buffer) that performs a data processing function or a cache buffer (Cache Buffer) that performs a caching function.

Each of the plurality of page buffers PB may be connected to the memory cell array 210 through a bit line BL. The page buffer PB may continuously supply a sensing current to the bit line BL to measure the threshold voltage of the memory cells during the read operation and the write operation. The page buffer PB may perform a read operation by detecting a current amount that changes according to the data storage state of the memory cell.

The operation of the read and write circuit 230 may be performed in response to a page buffer control signal of the control logic 240.

The read and write circuit 230 may sense data of a memory cell during the read operation and output data DATA to the input/output buffer of the memory 200.

The control logic 240 may be connected to the address decoder 220, the read and write circuit 230, and the voltage generation circuit 250. The control logic 240 may receive a command CMD and a control signal CTRL from the memory controller 100 through the input/output buffer of the memory 200.

The control logic 240 may control the overall operation of the memory 200 in response to the control signal CTRL. The control logic 240 may output a control signal for adjusting the pre-charge voltage level of the sensing node of the plurality of page buffers (PB).

The control logic 240 may control the read and write circuit 230 to perform a read operation of the memory cell array 210. The voltage generation circuit 250 may output a read voltage Vread and a pass voltage Vpass used in the read operation in response to the voltage generation circuit control signal output from the control logic 240.

The temperature sensor 260 is provided for each memory die of the memory 200 to measure the temperature of the memory cell array 210. The temperature sensor 260 may continuously measure the temperature of the memory cell array 210 during the operation of the memory system 10. In particular, the temperature sensor 260 may measure the temperature of the memory block 211 that is the target of the write or read operation. For example, the temperature sensor 260 may measure the temperature (Tblkp) of the pth block, which is a natural number greater than or equal to 1 and less than or equal to N. The temperature sensor 260 may output the temperature (Tblkp) of the pth block to the input/output buffer of the memory 200.

The temperature sensor 260 may be one of various temperature sensors such as a PN-junction diode sensor, a Bipolar Junction Transistor (BJT)-based temperature sensor (Bandgap Temperature Sensor), a digital temperature sensor (Digital Thermal Sensor), or a structure in which multiple temperature sensors are used in combination. The types of the temperature sensor 260 are examples, and the types of the temperature sensor 260 are not limited thereto.

Referring to FIGS. 1 and 2, the memory controller 100 may receive the temperature (Tblkp) of the memory block measured by the temperature sensor 260 to determine the temperature of each memory block 211. According to one embodiment, the memory controller 100 can also estimate the temperature of the memory block 211 based on the temperature of the memory controller 100 by utilizing a temperature sensor separately provided inside or outside the memory controller 100. The temperature (Tblkp) of the memory block described below is assumed to be the temperature measured by the temperature sensor 260 unless otherwise described.

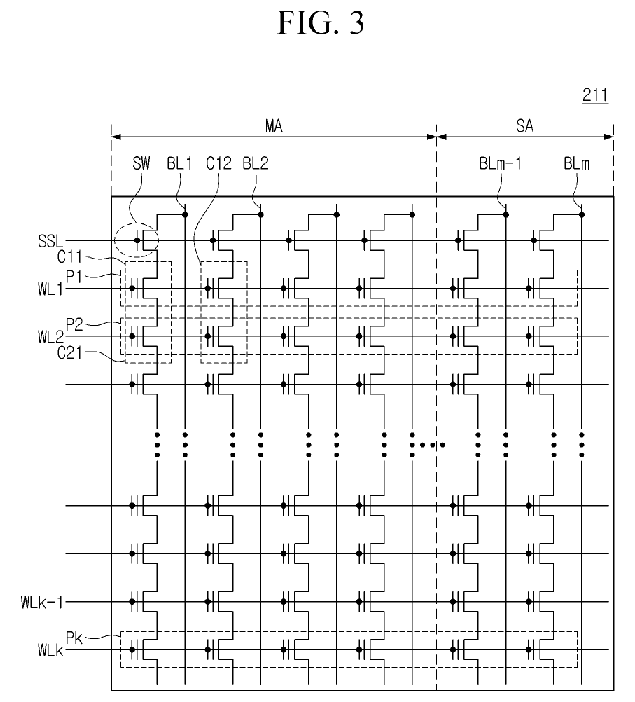

FIG. 3 is a circuit view showing the structure of a memory block shown in FIG. 2.

Referring to FIG. 3, each memory block 211 may be composed of a plurality of pages corresponding to the plurality of word lines WL and a plurality of strings corresponding to the plurality of bit lines BL.

The memory block 211 may be arranged such that the plurality of word lines WL and bit lines BL intersect each other. As shown in FIG. 3, each word line WL may be arranged in a row direction, and each bit line BL may be arranged in a column direction. However, the arrangement direction of the word lines WL and bit lines BL is not limited thereto, and the arrangement direction may be set in various ways. FIG. 3 shows, for example, that k word lines WL and m bit lines BL are arranged for natural numbers k and m greater than or equal to 1. Hereinafter, the direction from the first word line WL1 to the kth word line WLk is defined as the downward direction, the direction from the kth word line WLk to the first word line WL1 is defined as the upward direction, the direction from the first bit line BL1 to the mth bit line BLm is defined as the right direction, and the direction from the mth bit line BLm to the first bit line BL1 is defined as the left direction.

A memory cell connected to one of each word line WL and bit line (BL) may be defined. For example, a memory cell connected to the first word line WL1 and the first bit line BL2 may be defined as the 1-1 memory cell C11. Similarly, a memory cell connected to the second word line WL2 and the first bit line BL1 may be defined as the 2-1 memory cell C21.

A transistor may be arranged in each memory cell. A transistor arranged in a memory cell may include a drain, a source, and a gate, etc. The gate of the transistor may be connected to the word line WL directly or via another transistor. The drain or source of the transistor may be connected to a bit line BL directly or via another transistor.

Each memory cell may store at least 1 bit of data. For example, each memory cell can be a single-level cell SLC that stores 1 bit of data. As another example, each memory cell may be a multi-level cell MLC that stores 2 bits of data. As another example, each memory cell may be a triple-level cell TLC that stores 3 bits of data. As another example, each memory cell may be a quad-level cell QLC that stores 4 bits of data. As another example, the memory cell may include a plurality of memory cells that each store 5 or more bits of data.

The number of bits of data stored in each memory cell may be dynamically determined. For example, the same cell can be changed from a single-level cell to a triple-level cell.

A selection line SSL may be arranged in the upper direction of the first word line WL1 in the memory block 211. The selection line SSL may drive the switching element SW to control only a specific bit line BL to flow current. According to one embodiment, the selection line may be further arranged in the lower direction of the kth word line WL2 of the memory block 211.

The memory block 211 is composed of memory cells and may include a page connected to one word line WL. For example, the memory block 211 may include a first page P1 connected to a first word line WL1, a second page P2 connected to a second word line WL2, etc. Each page may include a plurality of chunks.

Each page may include a main area MA and a spare area SA. Actual user data (User Data) may be stored in the main area MA. Additional data used for verifying storage operations, etc. may be stored in the spare area SA. The spare area SA may store ECC (Error Correction Code) for correcting data errors in the main area MA, data related to chunk division of the corresponding page, Bad Block Marker for identifying bad blocks, management data such as block replacement history, other file system metadata, and reference data for determining read success/failure when performing a read operation.

The data storage capacity of the main area MA may be larger than the storage capacity of the spare area SA. In FIG. 3, the main area MA is arranged on the left side of the page and the spare area SA is arranged on the right side, but the arrangement of the main area MA and the spare area SA is not limited thereto and may be set in various ways.

Reading, writing, and erasing operations for the memory block 211 may be performed according to the current control of the word line WL and bit line BL of the memory block 211. The reading and writing operations for the memory block 211 may be performed in units of pages or chunks, and the erasing operation can be performed in units of memory blocks 211.

In FIG. 3, the structure is described centered on the memory block 211 as an example, but the temperature storage block 212 and the bad information block 213 may also have the same structure.

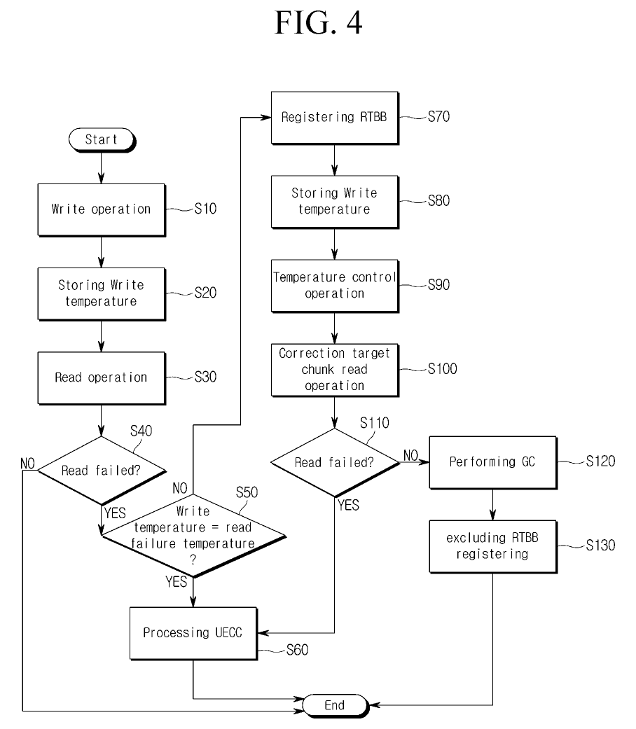

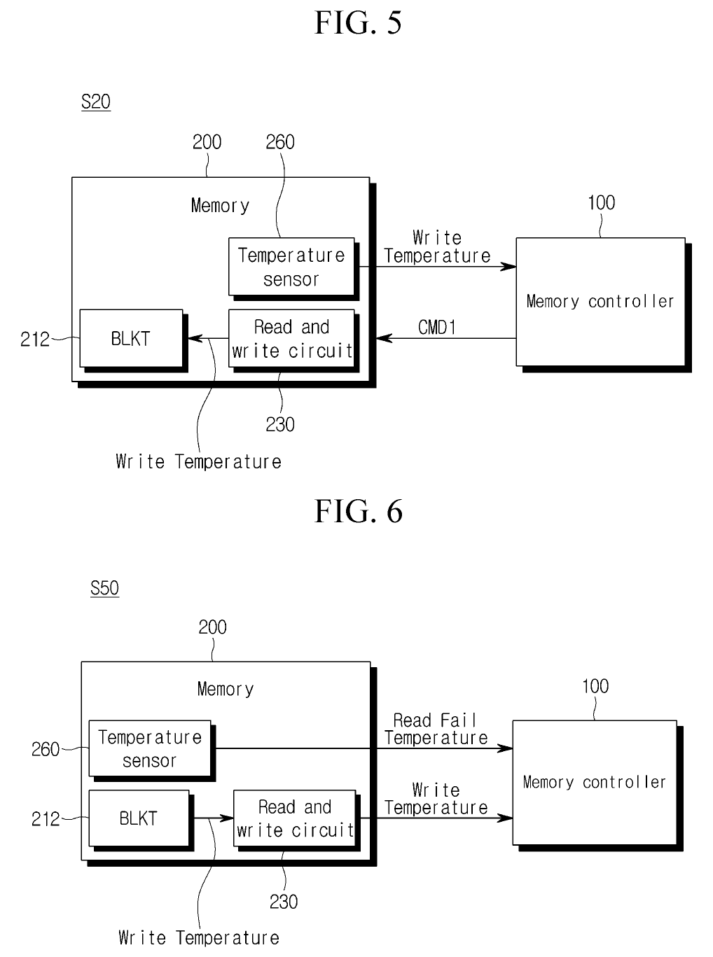

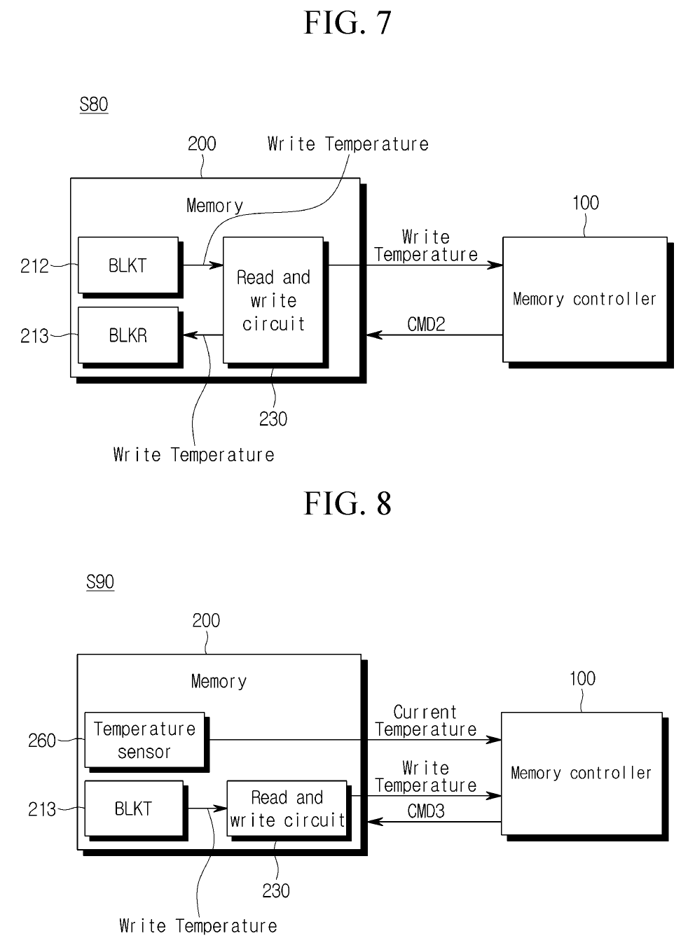

FIG. 4 is a flow chart showing a method of operating a memory system according to one embodiment. FIG. 5 is a diagram to describe S20 of FIG. 4. FIG. 6 is a diagram to describe S50 of FIG. 4. FIG. 7 is a diagram to describe S80 of FIG. 4. FIG. 8 is a diagram to describe S90 of FIG. 4. Hereinafter, the method of operating the memory system is described with reference to FIG. 4, and the above description may be referred to together with FIGS. 1-3.

In the read operation, the read and write circuit 230 may identify the stored data based on the threshold voltage of each memory cell. Therefore, the threshold voltage distribution of each memory cell must be maintained stably to perform a successful read operation. The temperature difference between the write operation and the read operation may cause a change in the threshold voltage of the memory cell due to various factors such as a change in the mobility of charge carriers, a change in charge distribution, an increase in current leakage, etc.

When the write operation is performed at a high temperature and the read operation is performed at a low temperature, the threshold voltage of the memory cell at the time of the read operation may have increased relative to the threshold voltage of the memory cell at the time of the write operation. Conversely, when the write operation is performed at a low temperature and the read operation is performed at a high temperature, the threshold voltage of the memory cell at the time of the read operation may have decreased relative to the threshold voltage of the memory cell at the time of the write operation. The threshold voltage change due to the temperature difference between the write operation and the read operation may ultimately cause a read failure, which may hinder the stable operation of the memory system 10.

Therefore, the memory system 10 according to one embodiment may operate stably by compensating for the temperature difference of the read and write operations described above.

Referring to FIG. 4, the method of operating the memory system according to one embodiment includes a step S10 in which the memory controller 100 performs a write operation on the memory 200.

The memory controller 100 may perform a write operation based on a program command or a write command transmitted by the host 20. The control logic 240 may receive a command from the memory controller 100 and control the read and write circuit 230. The read and write circuit 230 may store data in a page or chunk of a specific block under the control of the control logic 240.

Referring to FIGS. 4 and 5, the operating method of the memory system according to one embodiment includes a step S20 in which the memory controller 100 stores the temperature at which the write operation of each memory block 211 was performed in the temperature storage block 212.

In the step S20 in which the memory controller 100 stores the temperature at which the write operation of each memory block 211 was performed in the temperature storage block 212, the memory controller 100 may receive the temperature (Write Temperature) at the time of performing the write operation of each memory block. The memory controller 100 may transmit a first command CMD1 to the memory 200 to store the temperature (Write Temperature) at the time of performing the write operation of each memory block in the temperature storage block 212. The control logic 240 of the memory 200 may control the read and write circuit 230 based on the first command CMD1 to store the temperature (Write Temperature) at the time of performing the temperature write operation of each block in the temperature storage block 212.

According to one embodiment, the temperature sensor 260 may transmit the temperature (Write Temperature) at the time of performing the temperature write operation of each block to the memory controller 100. The memory controller 100 may classify the temperature into a certain range based on the temperature provided by the temperature sensor 260. For example, the memory controller 100 may classify and determine a temperature exceeding a predetermined upper temperature limit as a high temperature range. In addition, the memory controller 100 may classify and determine a temperature below a predetermined lower temperature limit as a low temperature range.

The memory controller 100 may classify and store the classified temperature range in bit units. For example, the memory controller 100 may classify the temperature of the high temperature range as a bit value of and store the classified value in the temperature storage block 212. In addition, the memory controller 100 may classify the temperature of the low temperature range as a bit value of and store the classified value in the temperature storage block 212. The memory controller 100 may transmit a first command CMD1 to the memory 200 to store the classified temperature range in the temperature storage block 212.

Referring to FIG. 4, the method of operating the memory system according to one embodiment includes a step S30 in which the memory controller 100 performs a first read operation on data stored in the memory. The step S30 of performing the first read operation may be activated by a read command transmitted by the host. The memory controller 100 may perform a read operation on all memory blocks 211 of the memory 200. Alternatively, the memory controller 100 may perform the read operation only on a specific memory block 211 of the memory 200.

The method of operating the memory system according to one embodiment includes a step S40 of determining a read failure in one or more chunks of a specific memory block 211 during the first read operation.

The memory controller 100 may perform a read verification operation during the read operation. In the read verification operation, the memory controller 100 may verify stored data (hereinafter, first data) based on the threshold voltage of the memory cell included in the main area of each page. Thereafter, the memory controller 100 may verify reference data (hereinafter, second data) for determining read success/failure included in the spare area SA of each page. The memory controller 100 may determine whether the first data is stored without being modified from the data stored during the write operation based on the second data.

The memory controller 100 may determine a read success if there is no modification of the first data or if the modification is negligible (for example, if the modification can be corrected by the error correction circuit 150 as described below). The memory controller 100 may determine a read failure if the modification of the first data is large. The memory controller 100 may determine a read success/failure in units of chunks of each page. If the memory controller 100 determines a read failure of the first data, it may operate the error correction circuit 150 to perform an error correction operation. The error correction circuit 150 may perform an error correction operation on a chunk determined to have a read failure based on the ECC stored in the spare area SA of each page. After the error correction operation is performed, the memory controller 100 may perform a read operation on the chunk determined to have a read failure again. If the memory controller 100 determines that the read success of a chunk in which a read failure is determined after an error correction operation is performed, the memory controller 100 may determine that the read success is for the chunk and perform a read operation for another chunk.

If a read failure occurs repeatedly in a specific chunk even after an error correction operation is performed, the memory controller 100 can determine that a read failure has occurred in the chunk in the first read operation.

In conclusion, the memory controller 100 may determine the read success/failure result for the chunk that has gone through the error correction operation as the read success/failure result for the corresponding chunk in the read failure determination step S40 of the first read operation.

Hereinafter, the chunk for which the read failure is determined in the read failure determination step S40 of the first read operation is designated as the correction target chunk. In addition, the memory block 211 including the read failure chunk is referred to as the correction target block.

The method of operating the memory system according to one embodiment may end the operation if the read success is determined (NO) for all chunks of the memory block 211 that are the subject of the determination in the read failure determination step S40. In FIG. 4, termination means completing the read, write, or erase operation for a specific chunk or block and performing the read, write, or erase operation for another chunk or block.

Referring to FIGS. 4 and 6, the method of operating the memory system according to one embodiment includes a step S50 of determining whether the temperature of the correction target block (hereinafter, the first temperature) when the write operation of data stored in the read failure chunk was performed and the temperature of the correction target block (hereinafter, the second temperature) when the first read operation was performed are the same, if the memory controller 100 determines (YES) that the read failure of a specific chunk in the read failure determination step S40. Here, the memory controller 100 can receive the temperature of the correction target block measured through the temperature sensor 260. Since the temperature sensor 260 is provided for each memory die, the temperature of the correction target block may be received from the temperature sensor 260 provided in the memory die including the correction target block.

“The temperature is the same” includes not only the case where the temperatures are completely the same, but also the case where the first temperature and the second temperature are included within a preset range. Additionally, “the temperature is the same” includes, in one embodiment, a case where the temperature sensor 260 measures the temperature of each memory block 211 in a temperature range, and the first temperature and the second temperature are in the same temperature range.

Referring to FIG. 6, the temperature sensor 260 may transmit the second temperature (Read Fail Temperature) to the memory controller 100. In addition, the read and write circuit 230 may transmit the first temperature (Write Temperature) to the memory controller 100 according to the command of the memory controller 100. The memory controller 100 may compare the received first temperature and the second temperature.

Referring again to FIG. 4, the method of operating the memory system according to one embodiment includes a step S60 of UECC processing a block to be corrected when the memory controller 100 determines that the first temperature and the second temperature are the same (YES). “UECC processing” means determining that a UECC occurs in a chunk to be corrected, determining and registering the block to be corrected as a bad block (RTBB; Run Time Bad Block), and storing failure information of the block to be corrected. “Bad block registration” means that the memory controller 100 stores failure information such as the address and bad content of the block including the chunk where UECC occurs in the bad information block 213. The memory controller 100 may perform the operation by excluding the bad block in subsequent write and read operations.

As described above, the memory controller 100 may determine that UECC occurs in the chunk to be compensated even though the first temperature and the second temperature are the same, and registers the block to be compensated as a bad block. This is because the read failure occurred for a separate reason, not due to a threshold voltage change caused by a temperature difference in the write and read operations. The subsequent steps S70 to S130 are steps for determining whether the read failure in the first read operation of the chunk to be compensated is caused by a temperature difference in the read and write operations, and recovering the data accordingly.

Referring to FIG. 4, the method of operating the memory system according to one embodiment includes a step S70 of registering the block to be compensated as a bad block when the memory controller 100 determines (NO) that the first temperature and the second temperature are different. The memory controller 100 may store information such as the address and the content of the block to be compensated in the bad information block 213.

Referring to FIGS. 4 and 7, the method of operating the memory system according to one embodiment may include a step S80 in which the memory controller 100 stores the first temperature in the bad information block 213.

Referring to FIG. 7, the memory controller 100 may control the read and write circuit 230 through the control logic 240 to receive the first temperature (Write Temperature) stored in the temperature storage block 212. Thereafter, the memory controller 100 may transmit a second command CMD2 to the memory 200 to control the read and write circuit 23 through the control logic 240 to store the first temperature (Write Temperature) in the bad information block 213. Through this step, the memory controller 100 may effectively perform verification and recovery on a chunk in which a read failure has occurred.

Referring to FIGS. 4 and 8, the method of operating the memory system according to one embodiment includes a step S90 in which the memory controller 100 performs a temperature control operation so that the temperature of the correction target block becomes equal to the first temperature.

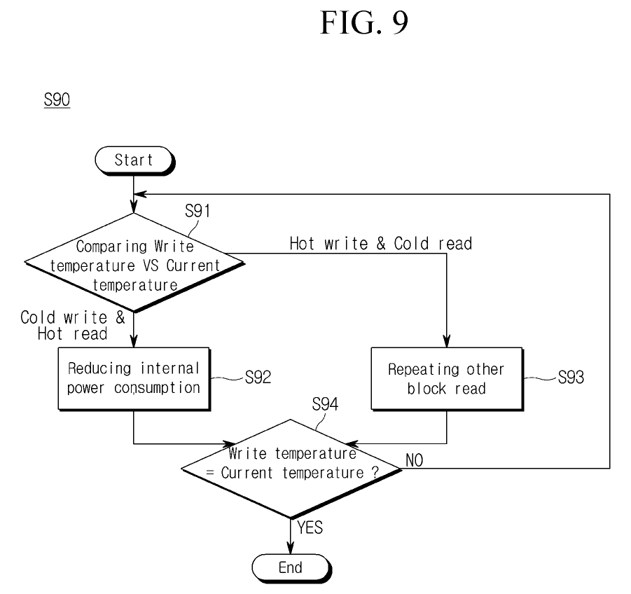

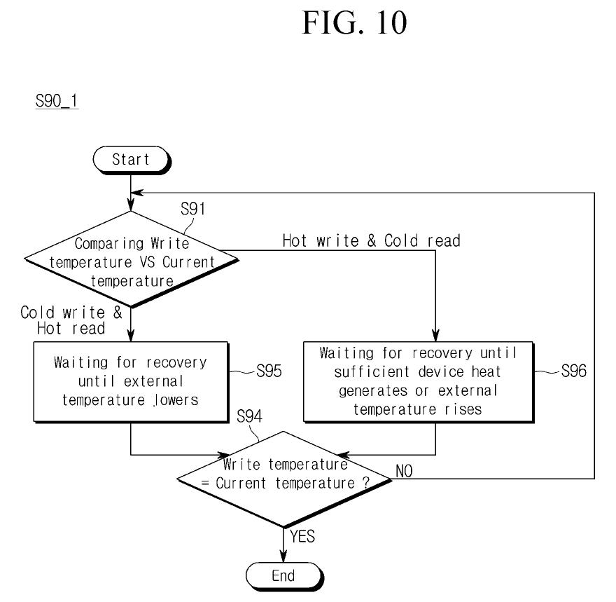

Referring to FIG. 8, the temperature sensor 260 may continuously transmit the current temperature (Current Temperature) of the correction target block to the memory controller (100). The memory controller (100) can control the read and write circuit (230) through the control logic (240) to receive the first temperature (Write Temperature) stored in the bad information block (213). The temperature sensor (260) can control the temperature of the correction target block by transmitting the third command (CMD3) to the memory (200). The specific temperature control operation of the memory controller (100) is described later in FIGS. 9 and 10.

Referring to FIG. 8, the temperature sensor 260 may continuously transmit the current temperature (Current Temperature) of the correction target block to the memory controller 100. The memory controller 100 may control the read and write circuit 230 through the control logic 240 to receive the first temperature (Write Temperature) stored in the bad information block 213. The temperature sensor 260 may control the temperature of the correction target block by transmitting the third command CMD3 to the memory 200. The specific temperature control operation of the memory controller 100 is described later in FIGS. 9 and 10.

According to one embodiment, the memory controller 100 may perform a read operation on all chunks of the memory cell array 210 when performing the second read operation. According to another embodiment, the memory controller 100 may perform a read operation only on the chunk to be corrected when performing the second read operation.

According to one embodiment, the method of operating the memory system may include a step S110 in which the memory controller 100 determines whether a read failure occurs again for a chunk that has failed to read in the second read operation.

According to one embodiment, the operating method of the memory system may include a step (S60) in which the memory controller (100) UECC-processes a block including the chunk to be corrected when the read failure of the chunk to be corrected is determined again (YES) in the second read operation. This step is a step after the temperature control operation is performed so that the temperature of the block to be corrected becomes the same as the first temperature. The memory controller (100) determines that the read failure that occurs repeatedly is not due to the difference between the read and write temperatures, as the read failure is maintained despite the temperature control operation, and may UECC-process the block to be corrected.

The method of operating the memory system according to one embodiment includes a step S50 of determining whether the first temperature and the second temperature are the same, and a step S110 of re-determining the read failure through a temperature control operation step S90 and a second read operation step S100, thereby excluding a block in which a separate UECC that is not caused by the temperature difference between the write and read operations occurs, and performing the operation, so that the operation can be performed stably. The step S110 of re-determining the read failure may be similar to the step S40 described above.

The method of operating the memory system according to one embodiment includes a step S120 in which, if the read success of the correction target chunk is determined (NO) in the second read operation, the memory controller 100 performs a GC (Garbage Collection) operation on the correction target block. The GC operation refers to an operation of moving and storing data of a specific block to another block and deleting data stored in a specific block.

Even if the reading of a block and chunk whose write and read temperatures are the same through the temperature control operation is successful, a block in which a read failure occurs after the above-described steps S10 to S50, S70 to S110 is a block vulnerable to temperature change. Therefore, the memory controller 100 may move and store data of the correction target block to another block that is not vulnerable to temperature in this step to ensure stable operation of the memory system 10 in the future.

The method of operating the memory system according to one embodiment may include a step S130 in which the memory controller 100 excludes a block to be corrected from bad block registration after the GC operation. “Excluding from bad block registration” means that the memory controller 100 deletes information stored in the bad information block 213 related to the block to be corrected. Or, it means that the memory controller 100 stores additional information about no longer determining it as a bad block in the bad information block 213). The method of operating the memory system according to one embodiment may end the operation after the bad block exclusion step S130.

The method of operating the memory system according to one embodiment may perform an effective read operation on data by compensating for a read failure due to a temperature difference between write and read operations. In addition, the operating method of the memory system according to one embodiment may determine a read failure due to a separate factor other than a temperature difference between write and read operations, process UECC and register it as a bad block, and exclude the bad block from the subsequent data system 10 operation, thereby enabling stable operation. In addition, the method of operating the memory system according to one embodiment can ensure the stability of long-term memory operation by performing a GC operation on a block vulnerable to temperature even after resolving a read failure due to a temperature difference between a write and read operation through a temperature control operation.

FIG. 9 is a flow chart showing a temperature control operation according to one embodiment.

Referring to FIG. 9, the temperature control operation step S90 according to one embodiment may include a step S91 in which the memory controller 100 compares the first temperature (i.e., the write temperature) with the current temperature of the block to be compensated. This step may be performed by the memory controller 100 in the same manner as the method illustrated in FIG. 8.

The temperature control operation step S90 according to one embodiment may include a step S92 in which the memory controller 100 reduces the internal power consumption of the memory 200 when the first temperature is lower than the current temperature of the block to be compensated (Cold write & Hot read). The memory controller 100 may reduce the internal power consumption of the memory 200 by utilizing various methods such as the number of read and write operations, cycle control, etc. The current temperature of the block where the UECC occurred may be lowered through the internal power consumption reduction operation of the memory controller 100 to become the same as the first temperature.

The temperature control operation step S90 according to one embodiment may include a step S93 in which the memory controller 100 repeatedly performs a read operation on a memory block 211 other than the correction target block when the first temperature is higher than the current temperature of the correction target block (Hot write & Cold read). The current temperature of the correction target block may be increased through the repeated read operation of the memory controller 100 on another block and become the same as the first temperature.

The temperature control operation step S90 according to one embodiment may include a step S94 in which the memory controller 100 determines whether the first temperature and the current temperature of the correction target block are the same after the internal power consumption reduction step S92 or the other block read operation repetition step S93. The temperature control operation step S90 according to one embodiment may end the temperature control operation when the memory controller 100 determines (YES) in this step that the first temperature and the current temperature of the correction target block are the same. Whether the first temperature and the current temperature are the same may be determined in step S92 as described for step S50 of FIG. 4, above. The temperature control operation step S90 according to one embodiment may repeatedly perform the temperature control operations S91, S92, and S93 if the memory controller 100 determines (NO) that the first temperature and the current temperature of the block to be compensated are different in this step.

For smooth operation of the memory system 10, in the read operation of the memory system 10 by the command of the host 20, the memory system 10 must transmit a response to the host 20 within a certain time. The temperature control operation step S90 according to one embodiment may allow the memory controller 100 to actively and quickly adjust the temperature of the block to be compensated and quickly transmit a response to the host 20.

FIG. 10 is a flow chart showing a temperature control operation according to another embodiment.

The temperature control operation step S90 of FIG. 4 may be replaced with the temperature control operation step S90_1 according to another embodiment of FIG. 10.

Referring to FIG. 10, the temperature control operation step S90_1 according to another embodiment may include a step S91 in which the memory controller 100 compares the first temperature with the current temperature of the block to be corrected, and a step S94 in which the first temperature and the current temperature of the block to be corrected are the same, similar to the temperature control operation step S90 according to one embodiment. The operation of the step that overlaps with the temperature control operation step S90 according to one embodiment is the same, and the description thereof is omitted below.

The temperature control operation step S90_1 according to another embodiment may include a step S95 in which the memory controller 100 waits for a data recovery operation until the temperature of the external device of the memory 200 is sufficiently lowered when the first temperature is lower than the current temperature of the block to be compensated (Cold write & Hot read). The external device of the memory 200 refers to various electronic devices such as a vehicle, a communication device, etc., in which the memory 200 is included. The memory controller 100 may wait for data recovery of the block to be compensated until the temperature of the external device of the memory 200 is lowered, such as during the early morning or evening hours. The current temperature of the block to be compensated may become equal to the first temperature after waiting for a predetermined time period.

The temperature control operation step S90_1 according to another embodiment may include a step S96 in which the memory controller 100 waits for data recovery until the temperature of the external device of the memory 200 becomes sufficiently high or, due to self-heating of the external device of the memory 200, the temperature becomes sufficiently high when the first temperature is higher than the current temperature of the block to be corrected (Hot write & Cold read). The memory controller 100 may wait for data recovery of the block to be corrected until the temperature of the external device of the memory 200 becomes low, such as during the day. Alternatively, the memory controller 100 may continuously monitor the current temperature of the block to be corrected through the temperature sensor 260. Through this, the memory controller may wait for data recovery of the block to be corrected until the temperature of the block to be corrected becomes sufficiently high due to sufficient heat generation of the external device of the memory 200. The current temperature of the block to be compensated may increase to the same as the first temperature after waiting for another predetermined time period of the memory controller 100 or after the external device heats up the memory 200.

In a read operation performed by the memory system 10 on its own without a command from the host 20, the memory system 10 may be capable of operating the system even if it does not transmit a response to the host 20 within a certain time. The temperature control operation S90_1 according to another embodiment may achieve smooth operation of the memory system 10 without separate power consumption or speed reduction of the correction target block, although the temperature control speed of the correction target block is slow.

The memory system and the operation method of the memory system according to various embodiments of the present specification may be described as follows.

According to one embodiment of the present disclosure, a method of operating a memory system including a memory device including a plurality of memory blocks and a temperature sensor configured to measure the temperature of the memory blocks; and a memory controller configured to control the memory device, the method may include a step in which the memory controller performs a write operation on the memory device at a first temperature of the memory blocks; a step in which the memory controller performs a first read operation on the memory device at a second temperature of the memory blocks according to a request of a host; a step in which the memory controller compares the first temperature with the second temperature when it determines that a read failure of a specific block occurs in the first read operation; and a step in which the memory controller performs a second read operation on the specific block in response to the temperature of the specific block being within a temperature range equal to the first temperature when the first temperature and the second temperature are included in different temperature ranges.

The method of operating the memory system may further include a step in which the memory controller divides the first temperature of each memory block into a bit value according to a temperature range and stores the first temperature in a temperature storage block.

In addition, the method of operating the memory system may further include a step in which, if the first temperature and the second temperature are included in different temperature ranges, the memory controller determines the specific block as a bad block and stores failure information of the specific block in a bad information block, and, if the first temperature and the second temperature are included in the same temperature range, the memory controller determines that a UECC (Uncorrectable Error Correction Code) occurs in a chunk in which a read failure of the specific block occurs.

In addition, the method of operating the memory system may further include a step in which the memory controller stores the first temperature of the specific block stored in the temperature storage block in the bad information block.

In addition, the method of operating the memory system may further include a step in which the memory controller controls the temperature of the specific block so that the current temperature of the specific block and the first temperature of the specific block stored in the bad information block are within the same temperature range.

In addition, the method of operating the memory system may further include a step of performing a GC (Garbage Correction) operation on the specific block, if the memory controller determines that the specific block is read successfully in the second read operation; a step of the memory controller no longer determining the specific block as a bad block after performing the GC operation; and a step of determining that a UECC occurs in a chunk where the read failure of the specific block occurs and maintaining the bad block determination for the specific block, if the memory controller determines that the read failure in the second read operation.

In addition, the step of performing the second read operation may include a step in which the memory controller may perform the second read operation only for the specific block.

The step in which the memory controller controls the temperature of the specific block so that the current temperature of the specific block and the first temperature of the specific block stored in the bad information block are within the same temperature range may include a step for reducing power consumption of operating the memory device, if the current temperature of the specific block is included in a temperature range higher than a temperature range including a first temperature of the specific block; and a step for repeating a read operation for a block other than the specific block of the memory device, if the current temperature of the specific block is included in a temperature range lower than a temperature range including a first temperature of the specific block.

In addition, the step in which the memory controller controls the temperature of the specific block so that the current temperature of the specific block and the first temperature of the specific block stored in the bad information block are within the same temperature range may include a step of waiting for a data recovery operation until the temperature of an external device of the memory device becomes sufficiently low, if the current temperature of the specific block is included in a temperature range higher than a temperature range including a first temperature of the specific block; and a step of waiting for a data recovery operation until the temperature of the external device of the memory device becomes sufficiently high or the temperature becomes sufficiently high by self-heating of the external device of the memory device, if the current temperature of the specific block is included in a temperature range lower than a temperature range including a first temperature of the specific block.

In addition, the step of performing the write operation at the first temperature may include a step of measuring the first temperature of the memory block through the temperature sensor provided in each of the plurality of memory dies including the memory block and included in the memory device, and the step of performing the first read operation on the memory device at the second temperature may include a step of measuring the second temperature of the memory block through the temperature sensor provided in each of the plurality of memory dies including the memory block and provided in the memory device.

According to another embodiment, a memory system may include a memory device including a plurality of memory blocks and a temperature sensor configured to measure the temperature of the memory blocks; and a memory controller for controlling the memory device. The memory controller may be configured to compare a first temperature of the specific block at a write operation prior to the first read operation with a second temperature of the specific block at the first read operation, ff a read failure of a specific block is determined in a first read operation for the memory block, and perform a second read operation for the specific block in response to the temperature of the specific block being located within the same temperature range as the first temperature, if the first temperature and the second temperature are included in different temperature ranges.

In addition, the memory device may further include a temperature storage block configured to store the temperature of each of the plurality of memory blocks, and the memory controller may distinguish the first temperature of each of the memory blocks into a bit value according to a temperature range and store the first temperature in the temperature storage block.

In addition, the memory device may further include a bad information block configured to store bad information of the memory block determined to be a bad block, and the memory controller may determine the specific block as a bad block and stores failure information of the specific block in the bad information block, if the first temperature and the second temperature are included in different temperature ranges, and determine that a UECC occurs in a chunk in which a read failure of the specific block occurs, if the first temperature and the second temperature are included in the same temperature range.

The memory controller stores the first temperature of the specific block stored in the temperature storage block in the bad information block.

The memory controller may control the temperature of the specific block so that the current temperature of the specific block and the first temperature of the specific block stored in the bad information block are in the same temperature range.

The memory controller may perform a GC operation on the specific block, if the second read operation determines that the specific block is read successfully, and the specific block is no longer determined as a bad block, after the GC operation is performed, and determine that a UECC occurs in a chunk where the read failure of the specific block occurred, if the second read operation determines that the specific block is read-failed, and maintain the determination of the specific block as a bad block.

In addition, the memory controller may perform the second read operation only for the specific block.

In addition, the memory controller may reduce power consumption for operating the memory device, if the current temperature of the specific block is included in a temperature range higher than a temperature range including the first temperature of the specific block, and repeat a read operation for a block other than the specific block of the memory device, if the current temperature of the specific block is included in a temperature range lower than a temperature range including the first temperature of the specific block.

The memory controller may wait for a data recovery operation until the temperature of an external device of the memory device is sufficiently lowered, if the current temperature of the specific block is included in a temperature range higher than a temperature range including a first temperature of the specific block, and wait for a data recovery operation until the temperature of the external device of the memory device is sufficiently higher or the temperature of the external device of the memory device is sufficiently higher due to self-heating of the memory device, if the current temperature of the specific block is included in a temperature range lower than a temperature range including a first temperature of the specific block.

In addition, the memory device may include a plurality of memory dies including a plurality of memory blocks, and the temperature sensor is provided in each of the memory dies and configured to measure the temperature of the memory blocks.

In addition, the memory controller may classify the memory blocks into a high temperature range if the temperature of the memory blocks exceeds a preset upper temperature limit, and into a low temperature range if it exceeds a preset lower temperature limit.

In addition, if the memory controller determines that a read failure of a specific block occurs in a first read operation for the memory block, and if the first temperature is included in the high temperature range and the second temperature is included in the low temperature range, the memory controller may perform a second read operation for the specific block in response to the temperature of the specific block being located in the high temperature range.

Although the present invention has been described with reference to the illustrative drawings, it is to be understood that the present invention is not limited to the embodiments and drawings disclosed in this specification, and those skilled in the art will appreciate that various modifications are possible without departing from the scope and spirit of the present invention. Further, although the operating effects according to the configuration of the present invention are not explicitly described while describing an embodiment of the present invention, it should be appreciated that predictable effects are also to be recognized by the configuration.

### DESCRIPTION OF NUMERAL REFERENCES

10: Memory system
20: Host
100: Memory controller
200: Memory

1. A method of operating a memory system comprising a memory device comprising a plurality of memory blocks and a temperature sensor configured to measure the temperature of the memory blocks; and a memory controller configured to control the memory device, the method comprising:
a step in which the memory controller performs a write operation on the memory device at a first temperature of the memory blocks;
a step in which the memory controller performs a first read operation on the memory device at a second temperature of the memory blocks according to a request of a host;
a step in which the memory controller determines whether a read failure of a specific block occurred in the first read operation;
a step in which the memory controller compares the first temperature with the second temperature in response to determining that the read failure of the specific block occurred in the first read operation; and
a step in which the memory controller performs a second read operation on the specific block in response to the temperature of the specific block being within a temperature range equal to the first temperature when the first temperature and the second temperature are included in different predetermined temperature ranges.

2. The method of operating the memory system of claim 1, further comprising:
a step in which the memory controller encodes the first temperature of each memory block into a bit value according to a predetermined temperature range and stores the encoded first temperature in a temperature storage block; and
a step in which, when the first temperature and the second temperature are included in different predetermined temperature ranges, the memory controller determines the specific block as a bad block and stores failure information of the specific block in a bad information block, and, when the first temperature and the second temperature are included in the same predetermined temperature range, the memory controller determines that a UECC (Uncorrectable Error Correction Code) occurs in a chunk in which a read failure of the specific block occurs.

3. The method of operating the memory system of claim 2, further comprising:
a step in which the memory controller stores the first temperature of the specific block stored in the temperature storage block in the bad information block; and
a step in which the memory controller controls the temperature of the specific block so that the current temperature of the specific block and the first temperature of the specific block stored in the bad information block are within the same predetermined temperature range.

4. The method of operating the memory system of claim 3, further comprising:
a step of performing a GC (Garbage Correction) operation on the specific block, when the memory controller determines that the specific block is read successfully in the second read operation;
a step of the memory controller no longer determining the specific block as a bad block after performing the GC operation; and
a step of determining that a UECC occurs in a chunk where the read failure of the specific block occurs and maintaining the bad block determination for the specific block, when the memory controller determines that the read failure in the second read operation.

5. The method of operating the memory system of claim 3, wherein the step of performing the second read operation comprises a step in which the memory controller performs the second read operation only for the specific block.

6. The method of operating the memory system of claim 3, wherein the step in which the memory controller controls the temperature of the specific block so that the current temperature of the specific block and the first temperature of the specific block stored in the bad information block are within the same predetermined temperature range comprises,
a step for reducing power consumption of operating the memory device, when the current temperature of the specific block is included in a predetermined temperature range higher than a predetermined temperature range including a first temperature of the specific block; and
a step for repeating a read operation for a block other than the specific block of the memory device, when the current temperature of the specific block is included in a predetermined temperature range lower than a predetermined temperature range including a first temperature of the specific block.

7. The method of operating the memory system of claim 3, wherein the step in which the memory controller controls the temperature of the specific block so that the current temperature of the specific block and the first temperature of the specific block stored in the bad information block are within the same predetermined temperature range comprises,
a step of waiting for a data recovery operation until the temperature of an external device of the memory device becomes sufficiently low, when the current temperature of the specific block is included in a predetermined temperature range higher than a predetermined temperature range including a first temperature of the specific block; and
a step of waiting for a data recovery operation until the temperature of the external device of the memory device becomes sufficiently high or the temperature becomes sufficiently high by self-heating of the external device of the memory device, when the current temperature of the specific block is included in a predetermined temperature range lower than a predetermined temperature range including a first temperature of the specific block.

8. The method of operating the memory system of claim 1, wherein the step of performing the write operation at the first temperature comprises,
a step of measuring the first temperature of the memory block through the temperature sensor provided in each of the plurality of memory dies comprising the memory block and included in the memory device, and
the step of performing the first read operation on the memory device at the second temperature comprises,
a step of measuring the second temperature of the memory block through the temperature sensor provided in each of the plurality of memory dies comprising the memory block and provided in the memory device.

9. A memory system comprising:
a memory device comprising a plurality of memory blocks and a temperature sensor configured to measure the temperature of the memory blocks; and
a memory controller for controlling the memory device,
wherein the memory controller is configured to:
compare a first temperature of the specific block at a write operation prior to a first read operation with a second temperature of the specific block at the first read operation, when a read failure of a specific block is determined in a first read operation for the memory block, and
perform a second read operation for the specific block in response to the temperature of the specific block being located within the same temperature range as the first temperature, when the first temperature and the second temperature are included in different predetermined temperature ranges.

10. The memory system of claim 9, wherein the memory device further comprises,
a temperature storage block configured to store a temperature of each of the plurality of memory blocks, and
the memory controller is configured to encode the first temperature of each of the memory blocks into a bit value according to a predetermined temperature range and stores the encoded first temperature in the temperature storage block.

11. The memory system of claim 10, wherein the memory device further comprises,
a bad information block configured to store failure information of the memory block determined to be a bad block, and
the memory controller is configured to:
determine the specific block as a bad block and store bad information of the specific block in the bad information block, when the first temperature and the second temperature are included in different predetermined temperature ranges, and
determine that an Uncorrectable Error Correction Code (UECC) occurs in a chunk in which a read failure of the specific block occurs, when the first temperature and the second temperature are included in the same predetermined temperature range.

12. The memory system of claim 11, wherein the memory controller is configured to store the first temperature of the specific block stored in the temperature storage block in the bad information block.

13. The memory system of claim 12, wherein the memory controller is configured to control the temperature of the specific block so that the current temperature of the specific block and the first temperature of the specific block stored in the bad information block are in the same predetermined temperature range.

14. The memory system of claim 13, wherein the memory controller is configured to:
perform a GC operation on the specific block, when the second read operation determines that the specific block is read successfully, and the specific block is no longer determined as a bad block, after the GC operation is performed, and
determine that a UECC occurs in a chunk where the read failure of the specific block occurred, when the second read operation determines that the specific block is read-failed, and maintains the determination of the specific block as a bad block.

15. The memory system of claim 13, wherein the memory controller is configured to perform the second read operation only for the specific block.

16. The memory system of claim 13, wherein the memory controller is configured to reduce power consumption for operating the memory device, when the current temperature of the specific block is included in a predetermined temperature range higher than a predetermined temperature range including the first temperature of the specific block, and to repeat a read operation for a block other than the specific block of the memory device, when the current temperature of the specific block is included in a predetermined temperature range lower than a predetermined temperature range including the first temperature of the specific block.

17. The memory system of claim 13, wherein the memory controller is configured to:
wait to perform a data recovery operation until the temperature of an external device of the memory device is sufficiently lowered, when the current temperature of the specific block is included in a predetermined temperature range higher than a predetermined temperature range including a first temperature of the specific block, and
wait to perform the data recovery operation until the temperature of the external device of the memory device is sufficiently higher or the temperature of the external device of the memory device is sufficiently higher due to self-heating of the memory device, when the current temperature of the specific block is included in a predetermined temperature range lower than a predetermined temperature range including a first temperature of the specific block.

18. The memory system of claim 9, wherein the memory device comprises a plurality of memory dies comprising a plurality of memory blocks, and the temperature sensor is provided in each of the memory dies and configured to measure the temperature of the memory blocks.

19. The memory system of claim 9, wherein the memory controller is configured to classify the memory blocks into a high temperature range when the temperature of the memory blocks exceeds a preset upper temperature limit, and into a low temperature range when the temperature of the memory blocks is less than a preset lower temperature limit.

20. The memory system of claim 19, wherein when the memory controller determines that a read failure of a specific block occurs in a first read operation for the memory block, and when the first temperature is included in the high temperature range and the second temperature is included in the low temperature range, the memory controller is configured to perform a second read operation for the specific block in response to the temperature of the specific block being located in the high temperature range.
